(19) United States
(12) Patent Application Publication
(10) Pub. No.: US 2026/0067953 A1
(43) Pub. Date: Mar. 5, 2026

(54) CONNECTION METHOD

(71) Applicant: SEIKO EPSON CORPORATION, Tokyo (JP)

(72) Inventor: Shun UEDA, KASHIWA-SHI (JP)

(21) Appl. No.: 19/311,745

(22) Filed: Aug. 27, 2025

(30) Foreign Application Priority Data
Aug. 27, 2024 (JP) 2024-145909

(51) Int. Cl. H04W 76/11; G03B 21/14; G06K 19/06

(52) U.S. Cl. CPC H04W 76/11; G03B 21/14; G06K 19/06037

(57) ABSTRACT

A projector 100 displays a first identification code CD1 for identifying the projector 100, a terminal device 300 acquires identification information IF for identifying an information processing device 200, the terminal device 300 captures an image of the first identification code CD1, the terminal device 300 transmits the first identification code CD1 and the identification information IF in association with each other to the management server 400, the information processing device 200 receives the first identification code CD1 corresponding to the identification information IF from the management server 400, and the information processing device 200 connects to the projector 100.

The present application is based on, and claims priority from JP Application Serial Number 2024-145909, filed Aug. 27, 2024, the disclosure of which is hereby incorporated by reference herein in its entirety.

### BACKGROUND

### 1. Technical Field

The present disclosure relates to a connection method.

### 2. Related Art

In the related art, a system is known that uses an image projected by a projection device to connect the projection device and an information processing device to each other through wireless communication.

For example, an image display system disclosed in JP-A 2008-15402 includes a projector, a notebook PC, and a mobile phone connected to the notebook PC via a cable. The image display system projects a connection information code using the projector, prompts the notebook PC to capture an image of the connection information code using the mobile phone and to transfer the image capturing result, and starts a wireless LAN connection with the projector using the transferred connection information code.

The act of using an information processing device that is assumed to be used while placed on a desk or the like, or using a device that is connected to the information processing device in a wired manner, to capture an image that was projected by the projection device may be burdensome for the user. For example, in JP-A-2008-15402, the burden on the user may be increased because there is the task of connecting the mobile phone and the notebook PC in a wired manner and the task of capturing an image projected by the projector using the mobile phone connected to the notebook PC in a wired manner. A camera mounted on an information processing device used by being placed on a desk or the like is often a front camera, and it is troublesome to capture an image projected by a projector using an imaging function of the information processing device, which may be a burden on a user.

### SUMMARY

A connection method of the present disclosure includes displaying, using a projection device, a first identification code for identifying the projection device; acquiring, by a second information processing device, first identification information for identifying a first information processing device; capturing, by the second information processing device, an image of the first identification code; using the second information processing device, associating the first identification code and the first identification information with each other and transmitting, to a third information processing device, information that associates the first identification code and the first identification information with each other; receiving, by the first information processing device, the first identification code corresponding to the first identification information from the third information processing device; and connecting to the projection device using the first information processing device.

### BRIEF DESCRIPTION OF THE DRAWINGS

FIG. 1 is a diagram showing a system configuration of a projection system.

FIG. 2 is a block diagram showing configuration of a projector.

FIG. 3 is a block diagram showing configuration of an information processing device.

FIG. 4 is a block diagram showing configuration of a terminal device.

FIG. 5 is a block diagram showing configuration of a management server.

FIG. 6 is a sequence diagram showing operations of the projection system according to a first embodiment.

FIG. 7 is a diagram showing system configuration of a projection system according to a second embodiment.

FIG. 8 is a block diagram showing configuration of a terminal device according to the second embodiment.

FIG. 9 is a sequence diagram showing operations of the projection system according to the second embodiment.

FIG. 10 is a sequence diagram of a projection system according to a first alternative embodiment.

FIG. 11 is a sequence diagram of a projection system according to a second alternative embodiment.

FIG. 12 is a sequence diagram of a projection system according to a third alternative embodiment.

### DESCRIPTION OF EMBODIMENTS

### Configuration of Projection System of First Embodiment

Hereinafter, a first embodiment will be described with reference to the accompanying drawings.

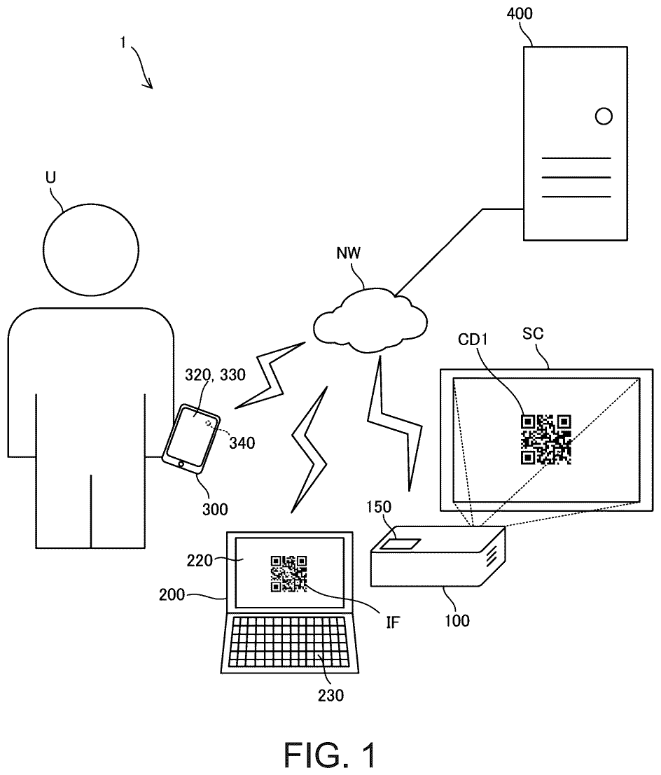

FIG. 1 is a diagram showing a system configuration of a projection system 1.

The projection system 1 includes a projector 100, an information processing device 200, a terminal device 300, and a management server 400. In the example projection system 1 shown in FIG. 1, one projector 100, one information processing device 200, one terminal device 300, and one management server 400 are provided. However, the number of the projectors 100, the information processing devices 200, the terminal device 300, and management servers 400 included in the projection system 1 are not limited to this, and it is sufficient as long as there are one or more each of projectors 100, information processing devices 200, terminal device 300, and management servers 400.

The projector 100 and the information processing device 200 are configured to be connectable to each other via a communication network NW. The information processing device 200 and the management server 400 are configured to be connectable via the communication network NW. The terminal device 300 and the management server 400 are configured to be connectable to each other via the communication network NW.

Although FIG. 1 shows an example in which the projector 100, the information processing device 200, and the terminal device 300 are connected to the communication network NW in a wireless manner, the projector 100, the information processing device 200, and the terminal device 300 may be connected to the communication network NW in a wired manner. Although FIG. 1 shows an example in which the management server 400 is connected to the communication network NW in a wired manner, the management server 400 may be connected to the communication network NW in a wireless manner.

The communication network NW includes, for example, a local area network (LAN), a wide area network (WAN), and the like. The communication network NW may include various devices such as an access point, a base station, a router, and a gateway.

The projector 100 displays an image based on data supplied by the information processing device 200 on a display surface SC. The display surface SC is, for example, a screen, a wall surface of a building, or the like. The projector 100 generates image light based on data supplied from the information processing device 200. The projector 100 projects the generated image light on a display surface SC. By this, an image corresponding to the data supplied from the information processing device 200 is displayed on the display surface SC. The projector 100 is an example of a “projection device”.

The information processing device 200 supplies data to the projector 100 for display by the projector 100. The information processing device 200 is, for example, a desktop, notebook, or tablet personal computer, or a mobile terminal such as a smartphone. In the present embodiment, the information processing device 200 is a device such as a desktop or notebook personal computer that is used in a state of being placed on a desk, a table, or the like. The information processing device 200 is an example of a “first information processing device”.

The terminal device 300 is a device having an imaging device that captures an image of a target object. The terminal device 300 is, for example, a mobile phone such as a feature phone or a smartphone, a personal computer such as a tablet type, or other mobile device. In the present embodiment, the terminal device 300 is a portable device that is used in a state of being hand held by the user U. The terminal device 300 is an example of a “second information processing device”.

The management server 400 manages information for associating the information processing device 200 with the projector 100. The management server 400 is, for example, a server device. Note that the management server 400 may be configured by one server device or may be configured by a plurality of server devices.

### 2. Configuration of Projector of First Embodiment

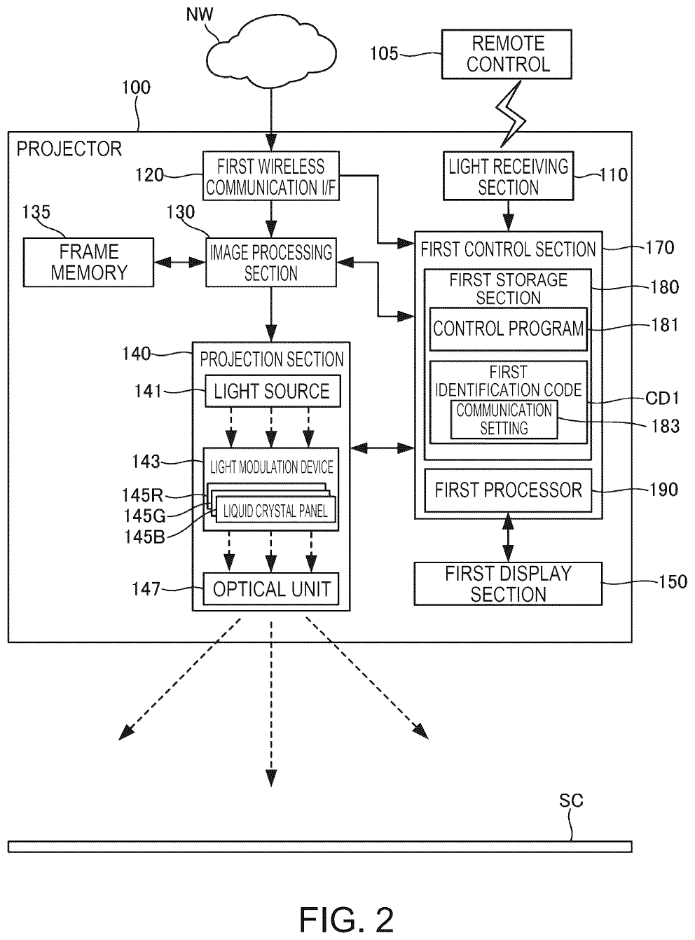

FIG. 2 is a block diagram showing configuration of the projector 100.

The configuration of the projector 100 will be described with reference to FIG. 2.

The projector 100 includes a light receiving section 110, a first wireless communication interface 120, an image processing section 130, a frame memory 135, a projection section 140, and a first control section 170. Hereinafter, interface is abbreviated as I/F.

The light receiving section 110 receives an infrared signal transmitted from a remote control 105. The light receiving section 110 outputs an operation signal corresponding to the received infrared signal to the first control section 170. The operation signal is a signal corresponding to the operated switch of the remote control 105.

The first wireless communication I/F 120 is connected to the communication network NW by wireless communication. For example, the first wireless communication I/F 120 may be configured to perform wireless communication by a communication scheme conforming to WiFi (registered trademark) and to connect to the communication network NW via a wireless LAN router (not shown) or the like. The communication scheme of the first wireless communication I/F 120 in the case of wireless communication is not limited to WiFi, and may be, for example, mobile communication using a cellular phone network or BlueTooth (registered trademark).

The first wireless communication I/F 120 is configured to be capable of mutual data communication with the information processing device 200 by being directly connected to the information processing device 200 without the communication network NW. For example, the first wireless communication I/F 120 may directly perform data communication with the information processing device 200 by a scheme such as Wi-Fi Direct or Bluetooth. In the present embodiment, the projector 100 and the information processing device 200 are configured to be capable of communicating data with each other using Wi-Fi Direct.

The frame memory 135 is connected to the image processing section 130. The frame memory 135 includes a plurality of banks. Each bank has a storage capacity capable of writing image data of one frame. The frame memory 135 is configured by, for example, a synchronous dynamic RAM (SDRAM). The image processing section 130 loads the image data that was input from the first wireless communication I/F 120 into the frame memory 135.

The image processing section 130 performs image processing on the image data that was loaded into the frame memory 135. The image processing performed by the image processing section 130 includes, for example, resolution conversion processing or resizing processing, distortion correction, shape correction processing, digital zoom processing, adjustment of the color tone and brightness of the image, and the like. The image processing section 130 executes processing designated by the first control section 170 and, as necessary, performs processing using parameters input from the first control section 170. The image processing section 130 can of course execute a combination of a plurality of image processing among the above. When image processing is completed, the image processing section 130 reads the data that was loaded into the frame memory 135 as display data and outputs the read display data to a panel drive section of the light modulation device 143. The panel drive section is not shown.

The image processing section 130 and the frame memory 135 are formed of, for example, an integrated circuit. The integrated circuit includes a large scale integration (LSI), an application specific integrated circuit (ASIC), a programmable logic device (PLD), and the like. The integrated circuit may include a field-programmable gate array (FPGA), a system-on-a-chip (SoC), and the like. A part of the configuration of the integrated circuit may include an analog circuit, or it may be a configuration of a combination of the first control section 170 and the integrated circuit.

The projection section 140 includes a light source 141, a light modulation device 143, and an optical unit 147.

The light source 141 includes a discharge type light source lamp such as an ultra-high pressure mercury lamp or a metal halide lamp, or a solid light source such as a light emitting diode or a semiconductor laser. The light emitted from the light source 141 is separated into red, green, and blue color light by a color separation optical system (not shown).

The light modulation device 143 includes three liquid crystal panels 145R, 145G, and 145B corresponding to the color components of red, green, and blue. Hereinafter, the liquid crystal panels 145R, 145G, and 145B are collectively referred to as liquid crystal panels 145. The color light separated into the red, green, and blue color components by the color separation optical system is incident on the liquid crystal panels 145R, 145G, and 145B, respectively.

The liquid crystal panels 145R, 145G, and 145B are each formed of a transmissive liquid crystal panel in which liquid crystal is sealed between a pair of transparent substrates. A pixel region including a plurality of pixels arranged in a matrix is formed in the liquid crystal panel, and a drive voltage can be applied to the liquid crystal for each pixel.

The light modulation device 143 includes a panel drive section that drives the liquid crystal panels 145R, 145G, and 145B. The panel drive section applies a drive voltage corresponding to the input display data to each pixel in the pixel region, and sets each pixel to a light transmittance corresponding to the display data. The light emitted from the light source 141 is modulated for each pixel by passing through the pixel region of the liquid crystal panel, and image light corresponding to the display data is formed for each color of light. The image light formed for each color is synthesized for each pixel by a color synthesis optical system (not shown) to become image light representing a color image. The optical unit 147 includes a projection lens and the like, and enlarges and projects the image light modulated by the liquid crystal panel 145 onto the display surface SC. By this, a display image based on arbitrary image data is displayed on the display surface SC.

In the present embodiment, the projector 100 includes a first display section 150. The first display section 150 includes a display device such as a display, and displays information such as characters or images. The first display section 150 may be configured by a touch panel, receive an operation without using the remote control 105, and transmit an operation signal corresponding to the operation to the first control section 170.

The first control section 170 is a computer device including a first storage section 180 and a first processor 190.

The first storage section 180 includes a memory such as a random access memory (RAM) or a read only memory (ROM). The RAM is used to temporarily store various data and the like, and the ROM stores a control program for controlling the operation of the projector 100, various types of setting information, and the like.

The first storage section 180 stores a control program 181. The control program 181 is a program such as firmware or an application program executed by the first processor 190.

The first storage section 180 stores a first identification code CD1. The first identification code CD1 includes information for identifying the projector 100. Specifically, the first identification code CD1 includes information used for connecting a device such as the information processing device 200 to the projector 100.

For example, the first identification code CD1 may include an IP address of the projector 100 as information for connecting to the projector 100 via the communication network NW. For example, the first identification code CD1 may include an SSID, a password, and the like as information for directly connecting to the projector 100 without going through the communication network NW.

The first identification code CD1 includes a communication setting 183. The communication setting 183 includes information about a setting of the connection method of connecting the projector 100 and the information processing device 200. Specifically, the communication setting 183 includes information on setting as to whether the projector 100 and the information processing device 200 are connected via the communication network NW or not via the communication network NW. The value of the communication setting 183 is changeable by an operation of the user U at the remote control 105 or the like.

When the value of the communication setting 183 is set to a value for performing the connection between the projector 100 and the information processing device 200 via the communication network NW, the projector 100 is connected to the communication network NW. When the value of the communication setting 183 is set to a value for performing the connection between the projector 100 and the information processing device 200 without the communication network NW, the projector 100 waits for the direct connection with the information processing device 200.

The first processor 190 is a calculation processing device including a central processing unit (CPU) or a micro processing unit (MPU). The first processor 190 executes the control program 181 to control each section of the projector 100. The first processor 190 may be configured by a single processor or a plurality of processors. The first processor 190 may be configured by a SoC that is integrated with a part or all of the first storage section 180 or other circuits. The first processor 190 may be configured by a combination of a CPU that executes a program and a digital signal processor (DSP) that executes predetermined calculation processing. Further, all of the functions of the first processor 190 may be implemented in hardware, or may be configured using a programmable device.

The first control section 170 encodes the first identification code CD1 stored as text data and the like in the first storage section 180 into the first identification code CD1 as image data that is recognizable using the mobile terminal device 300. The first control section 170 may encode the first identification code CD1 in a two dimensional barcode format or a one dimensional barcode format, for example. In the present embodiment, the first control section 170 encodes the first identification code CD1 stored as text data or the like, and generates the first identification code CD1 as a two dimensional barcode.

### 3. Configuration of Information Processing Device of First Embodiment

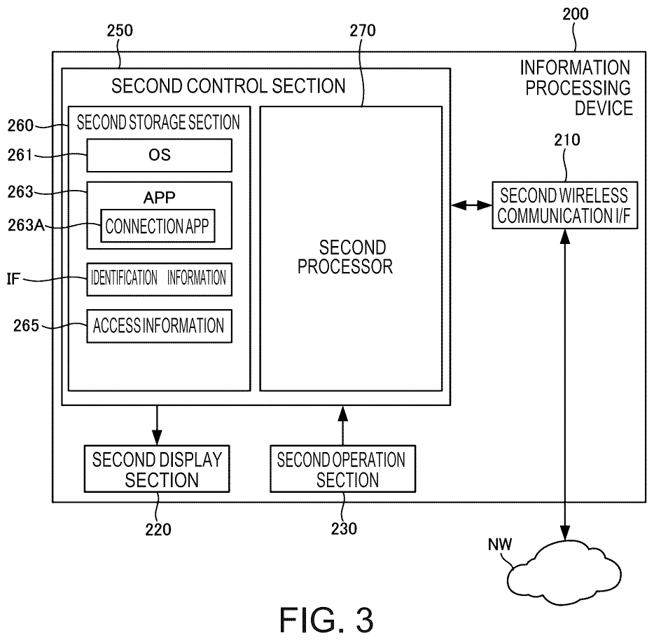

FIG. 3 is a block diagram showing configuration of the information processing device 200. The configuration of the information processing device 200 will be described with reference to FIG. 3.

The information processing device 200 includes a second wireless communication I/F 210, a second display section 220, a second operation section 230, and a second control section 250.

The second wireless communication I/F 210 is connected to the communication network NW by wireless communication. For example, the second wireless communication I/F 210 may be configured to perform wireless communication by a communication scheme conforming to WiFi and connect to the communication network NW via a wireless LAN router (not shown) or the like. The communication scheme of the second wireless communication I/F 210 in the case of wireless communication is not limited to WiFi and may be, for example, mobile communication using a cellular phone network or BlueTooth. The second wireless communication I/F 210 can be directly connected to the projector 100 using Wi-Fi Direct or the like without the communication network NW.

The second display section 220 includes a display panel such as a liquid crystal panel or an organic electro luminescence (EL) panel, and displays on the display panel an image based on image data input from the second control section 250. The information processing device 200 may include a touch panel that serves as both the second display section 220 and the second operation section 230.

The second operation section 230 includes an input device such as a mouse or a keyboard, and receives operations of the user U. The second operation section 230 outputs an operation signal corresponding to the received operation to the second control section 250. The second control section 250 determines that the operation is received when the operation signal is input from the second operation section 230.

The second control section 250 includes a second storage section 260 and a second processor 270.

The second storage section 260 includes a volatile memory such as a RAM and a nonvolatile memory such as a ROM. The second storage section 260 includes an auxiliary storage device such as a solid state drive (SSD) or a hard disk drive (HDD).

The second storage section 260 stores a second processor 270 operating system (OS) 261 executed by the second processor 270 and control programs such as an application program 263. The application program 263 is hereinafter referred to as the APP 263.

The second storage section 260 stores a connection APP 263A as the APP 263A. The connection APP 263A is an application program used for connecting the projector 100 and the information processing device 200. By the second processor 270 executing the APP 263, the second processor 270 causes the second display section 220 to display the identification information IF. At this time, the identification information IF displayed on the second display section 220 may be in a format of characters or the like that can be read by the user U, or may be in a format encoded into a one dimensional barcode, a two dimensional barcode, or the like that can be read by the terminal device 300.

The second storage section 260 stores identification information IF. The identification information IF is information that can identify the information processing device 200. The identification information IF is, for example, unique information such as an IP address or a manufacturing number of the information processing device 200. The identification information IF may be a PIN code or the like. The identification information IF is an example of “first identification information”.

The second storage section 260 stores access information 265. The access information 265 is information for accessing a device that provides a dedicated APP (to be described later) via the communication network NW. The access information 265 is, for example, a URL. In the present embodiment, since the dedicated APP is provided by the management server 400, the access information 265 includes information for accessing the management server 400.

The second processor 270 is a calculation processing device including a CPU or an MPU. The second processor 270 may be configured by a single processor or can be configured by a plurality of processors. The second processor 270 may be configured by a SoC integrated with a part or all of the second storage section 260 or other circuits. The second processor 270 may be configured by a combination of a CPU that executes a program and a DSP that executes predetermined calculation processing. Further, all the functions of the second processor 270 may be implemented in hardware, or may be configured using a programmable device.

### 4. Configuration of Terminal Device of First Embodiment

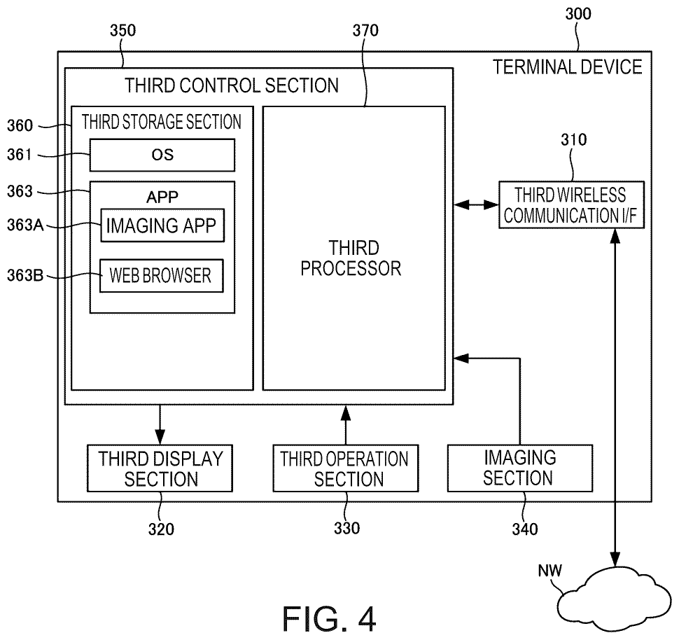

FIG. 4 is a block diagram showing configuration of the terminal device 300. The configuration of the terminal device 300 will be described with reference to FIG. 4.

The mobile terminal device 300 includes a third wireless communication I/F 310, a third display section 320, a third operation section 330, an imaging section 340, and a third control section 350.

The third wireless communication I/F 310 is connected to the communication network NW by wireless communication. For example, the third wireless communication I/F 310 may be configured to perform wireless communication by a communication scheme conforming to WiFi and connect to the communication network NW via a wireless LAN router (not shown) or the like. The communication scheme of the third wireless communication I/F 310 in the case of wireless communication is not limited to WiFi, and may be, for example, mobile communication using a cellular phone network or BlueTooth.

The third display section 320 includes a display panel such as a liquid crystal panel or an organic EL panel, and displays an image based on image data input from the third control section 350 on the display panel.

The third operation section 330 includes an input device such as a numeric keypad or a touch sensor, and receives operations of the user U. The third operation section 330 outputs an operation signal corresponding to the received operation to the third control section 350. The third control section 350 determines that an operation has been received when an operation signal is input from the third operation section 330. Note that in the present embodiment, the terminal device 300 includes a touch panel that serves as both the third display section 320 and the third operation section 330.

The imaging section 340 is a camera including an imaging element (not shown) such as a charge coupled device (CCD) sensor or a complementary metal oxide semiconductor (CMOS) sensor. The imaging section 340 is provided on a surface of the terminal device 300 different from a surface on which the third display section 320 is provided. In the present embodiment, the imaging section 340 is provided on a surface on the back side of the surface on which the third display section 320 is provided. Therefore, when the user U captures an image of a target object in front of the user U using the terminal device 300, the user U can check the image in the field of view of the imaging section 340 displayed on the third display section 320.

The third control section 350 includes a third storage section 360 and a third processor 370.

The third storage section 360 includes a volatile memory such as a RAM and a nonvolatile memory such as a ROM. The third storage section 360 includes an auxiliary storage device such as an SSD, an HDD, or an embedded Multi Media Card (eMMC).

The third storage section 360 stores an OS 361 executed by the third processor 370 and a control program such as the application program 363. The application program 363 is hereinafter referred to as the APP 363.

The third storage section 360 stores an imaging APP 363A as the APP 363. The imaging APP 363A is an application program used for performing imaging using the imaging section 340. By activating the imaging APP 363A, the third control section 350 can read characters included in the image acquired by the imaging section 340 or encoded information such as a one dimensional or two dimensional barcode. In the present embodiment, the third control section 350 causes the third display section 320 to display an image within the field of view of the imaging section 340 in real time while the imaging APP 363A is activated.

The third storage section 360 stores a web browser 363B as the APP 363. The Web browser 363B is an application program that displays information received from a server device or the like connected to the communication network NW. The Web browser 363B is also activated when a Web application is used.

The third processor 370 is a calculation processing device including a CPU or an MPU. The third processor 370 may be configured by a single processor or a plurality of processors. The third processor 370 may be configured by a SoC integrated with a part or all of the third storage section 360 or other circuits. The third processor 370 may be configured by a combination of a CPU that executes a program and a DSP that executes predetermined calculation processing. Further, all of the functions of the third processor 370 may be implemented in hardware, or may be configured using a programmable device.

### 5. Configuration of Management Server of First Embodiment

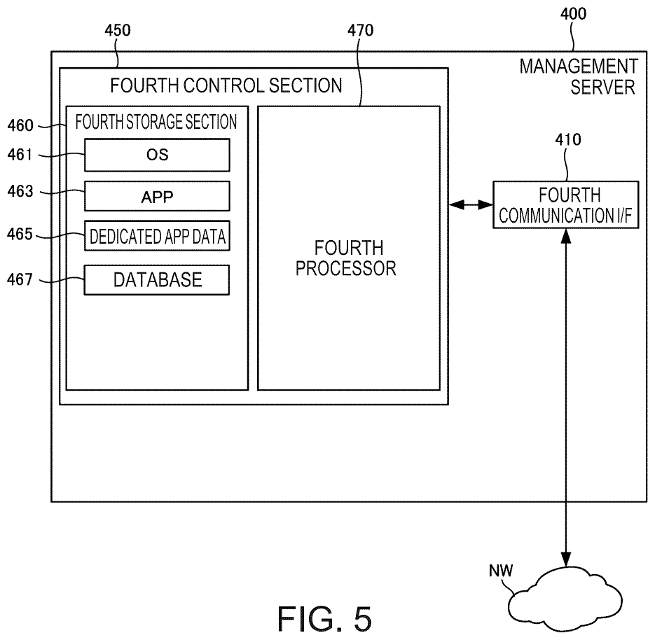

FIG. 5 is a block diagram showing the configuration of the management server 400. The configuration of the management server 400 will be described with reference to FIG. 5.

The management server 400 includes a fourth communication I/F 410 and a fourth control section 450.

The fourth communication I/F 410 includes, for example, a communication card such as a NIC, and performs mutual data communication with the terminal device 300 and the information processing device 200 via the communication network NW.

The fourth control section 450 includes a fourth storage section 460 and a fourth processor 470.

The fourth storage section 460 includes a volatile memory such as a RAM and a nonvolatile memory such as a ROM. The fourth storage section 460 includes an auxiliary storage device such as an SSD or an HDD.

The fourth storage section 460 stores an OS 461 executed by the fourth processor 470 and a control program such as an application program 463.

The fourth storage section 460 stores dedicated APP data 465. The dedicated APP data 465 includes a program and data for providing a dedicated APP, which is a web application, to the terminal device 300 that has accessed the management server 400 via the communication network NW.

The dedicated APP is a Web application for transmitting, to the management server 400, information that associates the first identification code CD1 and the identification information IF with each other. The terminal device 300 provided with the dedicated APP captures the first identification code CD1 using the imaging section 340 and acquires the first identification code CD1. The terminal device 300 that has received the dedicated APP acquires the identification information IF by an arbitrary means including input from the user U. The terminal then transmits information that associates the acquired first identification code CD1 with the identification information IF to the management server 400.

The fourth storage section 460 stores a database 467. The database 467 stores information that associates together identification information IF for identifying the information processing device 200 and a first identification code for identifying the projector 100. Each record of the database 467 includes, for example, identification information IF and first identification code CD1.

The fourth processor 470 is a calculation processing device including a CPU or an MPU. The fourth processor 470 may be configured by a single processor or a plurality of processors. The fourth processor 470 may be configured by a SoC integrated with a part or all of the fourth storage section 460 or other circuits. The fourth processor 470 may be configured by a combination of a CPU that executes a program and a DSP that executes predetermined calculation processing. Further, all of the functions of the third processor 370 may be implemented in hardware, or may be configured using a programmable device.

### 6. Operation of Projection System of First Embodiment

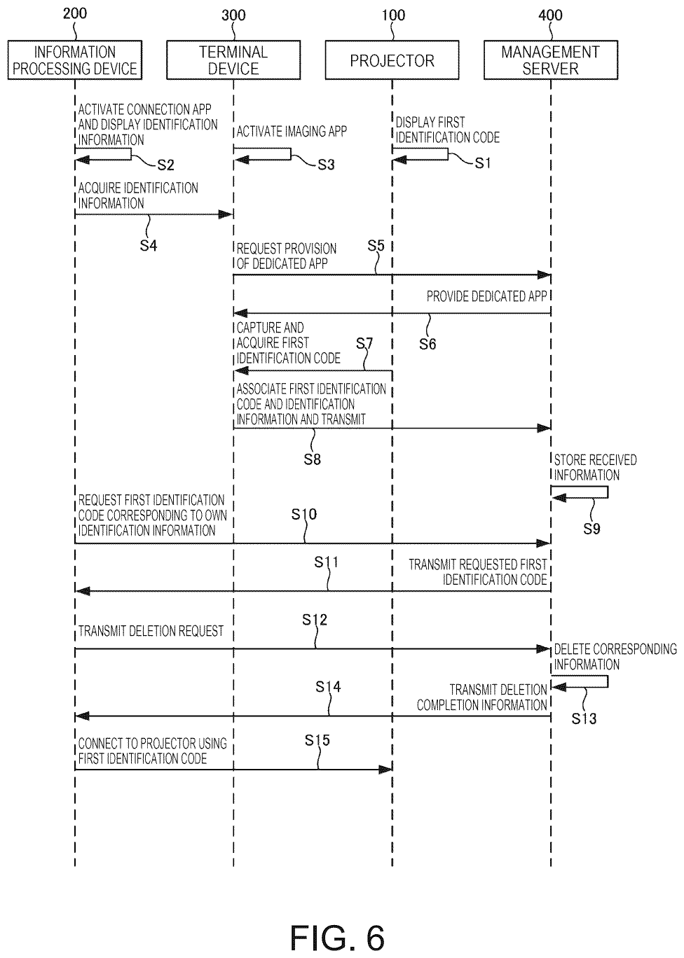

FIG. 6 is a sequence diagram showing operation of the projection system 1 according to the first embodiment.

The operation of the projection system 1 will be described with reference to the sequence diagram shown in FIG. 6.

First, the projector 100 displays the first identification code CD1 in accordance with an operation by the user U on the remote control 105 (step S1). At this time, the first control section 170 projects the first identification code CD1 in an encoded form. In the present embodiment, the projector 100 projects the first identification code CD1 encoded into a two dimensional barcode on the display surface SC using the projection section 140. Note that the projector 100 may be configured to display the first identification code CD1 using the first display section 150.

Next, the information processing device 200 activates the connection APP 263A in response to the operation by the user U on the second operation section 230, and displays the identification information IF using the second display section 220 (step S2). Specifically, in the present embodiment, the second control section 250 encodes information obtained by combining the identification information IF and the access information 265, and displays the encoded information on the second display section 220. The encoding format at this time is, for example, a one dimensional barcode, a two dimensional barcode, or the like.

Next, the terminal device 300 activates the imaging APP 363A in response to the operation by the user U on the third operation section 330 (step S3).

Next, by the operation by the user U, the terminal device 300 captures the an image of the information including identification information IF displayed on the second display section 220 and acquires the identification information IF (step S4). In the present embodiment, at this time, the third control section 350 acquires the access information 265 together with the identification information IF.

In the present embodiment, the user U can capture an image of the information including the identification information IF displayed by the second display section 220 using the imaging section 340 of the terminal device 300 that he or she is holding while visually checking the image in the field of view of the imaging section 340 displayed on the third display section 320. Therefore, it is easy to reduce the labor of the user U when the terminal device 300 acquires the identification information IF.

Next, the terminal device 300 activates the web browser 363B, and requests the management server 400 to provide the dedicated APP using the access information 265 acquired in step S4 (step S5).

At this time, the request transmitted from the terminal device 300 to the management server 400 may include the identification information IF. For example, when the access information 265 is a URL, the request transmitted in step S5 may be a request in which the identification information IF is added as a parameter to the URL indicated by the access information 265. In this case, the management server 400 can provide, to the terminal device 300, the dedicated APP in a state where the identification information IF is specified.

Next, the management server 400 provides the dedicated APP to the terminal device 300 (step S6).

By this, the terminal device 300 receives the dedicated APP via the web browser 363B.

Next, according to an operation by the user U, the terminal device 300 uses the dedicated APP to capture an image of the first identification code CD1 displayed by the projector 100, and acquires the first identification code CD1 (step S7).

In the present embodiment, since the request transmitted in step S5 includes the identification information IF, the dedicated APP provided to the terminal device 300 is in a state of having acquired, beforehand, the identification information IF that was acquired by the terminal device 300 in step S4.

In the present embodiment, the user U can capture the first identification code CD1 displayed by the projector 100 with the imaging section 340 of the hand-held terminal device 300 while visually checking the image in the field of view of the imaging section 340 displayed on the third display section 320. Therefore, it is easy to reduce the time and effort of the user U when the terminal device 300 acquires the first identification code CD1.

Next, the terminal device 300 associates the first identification code CD1 acquired in step S7 with the identification information IF acquired in step S4, and transmits information that associates first identification code CD1 and identification information IF to the management server 400 (step S8)

Next, the management server 400 stores information associating the first identification code CD1 and the identification information IF received from the terminal device 300 in the database 467 (step S9).

Next, in response to an operation by the user U, the information processing device 200 requests the management server 400 to transmit the first identification code CD1 corresponding to it own identification information IF (step S10). At this time, the information processing device 200 transmits, to the management server 400, a request including information about the identification information IF of the information processing device 200. Note that after the connection APP 263A is activated in step S2, the information processing device 200 may repeatedly make the request of step S10 without depending on an operation by the user U.

Next, the management server 400 extracts, from the database 467, the first identification code CD1 corresponding to the identification information IF included in the received request, and transmits the extracted first identification code CD1 to the information processing device 200, which was the transmission source of the request (step S11).

After receiving the first identification code CD1, the information processing device 200 transmits a deletion request to the management server 400 (step S12). The deletion request includes the identification information IF of the information processing device 200 or the received first identification code CD1, and requests that the information including the first identification code CD1 or the identification information IF be deleted from the database 467.

Next, the management server 400 that received the deletion request deletes the information corresponding to the deletion request from the database 467 (step S13).

Next, the management server 400 transmits deletion completion information, which is information indicating that deletion of the information according to the deletion request has been completed, to the information processing device 200, which was the transmission source of the deletion request (step S14).

After receiving the deletion completion information, the information processing device 200 connects to the projector 100 using the first identification code CD1 received in step S11 (step S15), and ends the sequence shown in FIG. 6.

Note that in step S15, the information processing device 200 refers to the communication setting 183 included in the first identification code CD1 and determines whether to connect to the projector 100 via the communication network NW or not via the communication network NW. In the present embodiment, before connecting to the projector 100, the information processing device 200 transmits the deletion request of step S12 and receives the deletion completion information of step S14, which requires connection to the communication network NW. Therefore, even when the projector 100 and the information processing device 200 are directly connected to each other without using the communication network NW, the information processing device 200 does not need to be reconnected to the communication network NW for transmission and reception of the deletion request.

### 7. Second Embodiment

A second embodiment will be described with reference to the accompanying drawings.

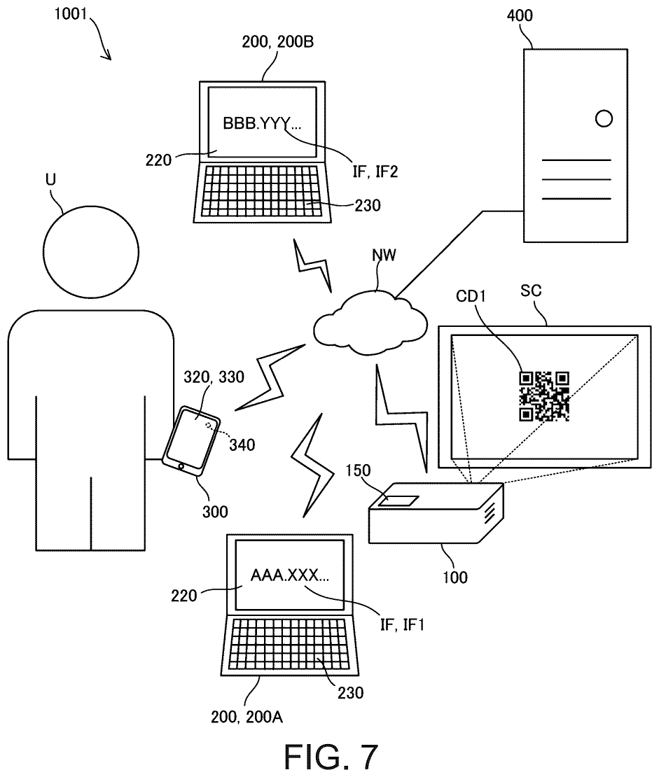

FIG. 7 is a diagram showing a system configuration of a projection system 1001 according to the second embodiment.

In addition to the configuration of the projection system 1 according to the first embodiment, the projection system 1001 includes an additional information processing device 200. However, the projection system 1001 may include three or more information processing devices 200.

Hereinafter, when the plurality of information processing devices 200 included in the projection system 1001 are to be distinguished from each other, one is referred to as a first information processing device 200A, and the other is referred to as a fourth information processing device 200B.

The identification information IF that is stored in the first information processing device 200A and that identifies the first information processing device 200A is referred to as first identification information IF1. The identification information IF that is stored in the fourth information processing device 200B and that identifies the fourth information processing device 200B is referred to as second identification information IF2.

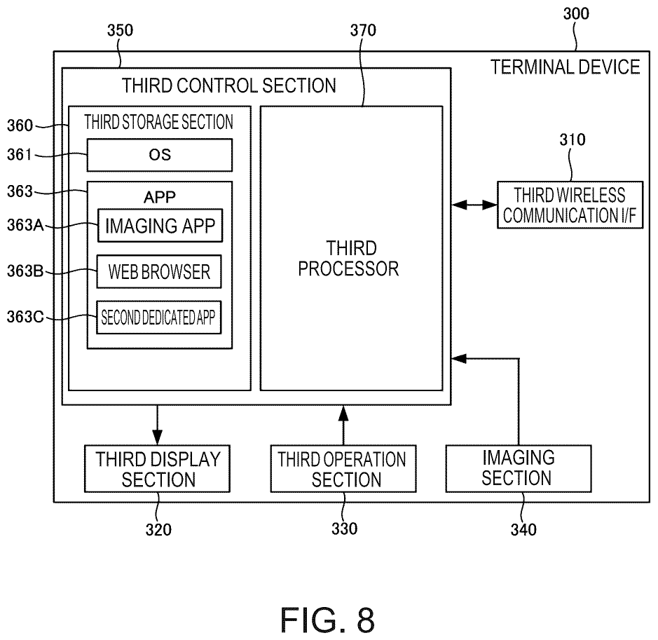

FIG. 8 is a block diagram showing a configuration of the terminal device 300 according to the second embodiment.

In the second embodiment, the third storage section 360 of the terminal device 300 stores a second dedicated APP 363C as the APP 363. The second dedicated APP 363C is an application program used in place of the dedicated APP that is provided as a Web application in the first embodiment.

The terminal device 300 that activated the second dedicated APP 363C is configured to be able to switch the operation mode between a single unit connection mode and a collective connection mode.

In the single unit connection mode, the terminal device 300 performs an operation for connecting one information processing device 200 and one projector 100 to each other, similarly to in the first embodiment.

In the collective connection mode, the terminal device 300 performs an operation for connecting one projector 100 and a plurality of information processing devices 200. Specifically, in the collective connection mode, the terminal device 300 that activated the second dedicated APP 363C captures an image of the first identification code CD1 in an encoded format, and acquires the first identification code CD1. In the collective connection mode, the terminal device 300 acquires plural sets of identification information IF corresponding to the plurality of information processing devices 200. In the present embodiment, the terminal device 300 in the collective connection mode receives input operations performed by the user U for plural sets of identification information IF. Further, in the collective connection mode, the terminal device 300 transmits, to the management server 400, information in which the acquired first identification code CD1 and the respective sets of identification information IF are associated with each other.

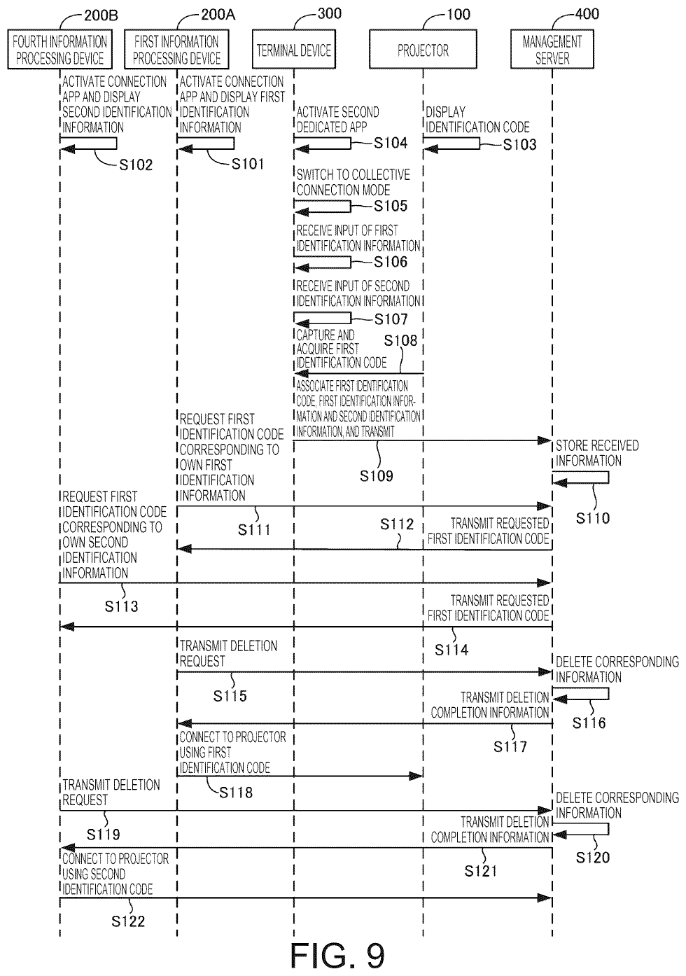

FIG. 9 is a sequence diagram showing the operation of the projection system 1001 according to the second embodiment.

The operation of the projection system 1001 will be described with reference to the sequence diagram shown in FIG. 9. Note that the following describes the operation when both the first information processing device 200A and the fourth information processing device 200B are connected to the projector 100.

First, the first information processing device 200A activates the connection APP 263A in response to an operation by the user U on the second operation section 230, and displays the first identification information IF1 using the second display section 220 (step S101). Similarly, the fourth information processing device 200B activates the connection APP 263A in response to an operation by the user U on the second operation section 230, and displays the second identification information IF2 using the second display section 220 (step S102). In the present embodiment, each information processing device 200 causes the second display section 220 to display the identification information IF as characters that can be read by the user U.

Next, the projector 100 displays the first identification code CD1 in accordance with the operation by the user U on the remote control 105 (step S103). At this time, the first control section 170 projects the first identification code CD1 in an encoded form.

Next, the terminal device 300 starts the second dedicated APP 363C in response to an operation by the user U on the third operation section 330 (step S104). After the second dedicated APP 363C is activated, the terminal device 300 displays, on the third display section 320, a screen for receiving an operation by the user U for selecting the operation mode of the terminal device 300.

Next, the terminal device 300 switches the operation mode of the terminal device 300 to the collective connection mode in accordance with the operation by the user U on the third operation section 330 (step S105).

Next, the terminal device 300 in the collective connection mode acquires plural sets of identification information IF. In the present embodiment, the terminal device 300 acquires the first identification information IF1 by receiving an input operation of the first identification information IF1 by the user U via the third operation section 330 (step S106). Similarly, the terminal device 300 acquires the second identification information IF2 by receiving an input operation of the second identification information IF2 by the user U via the third operation section 330 (step S107).

Note that the terminal device 300 in the collective connection mode may be configured to acquire plural sets of identification information IF by imaging each set of identification information IF using the imaging section 340.

Next, in accordance with the operation by the user U, the terminal device 300 in the collective connection mode captures and acquires the first identification code CD1 using the imaging section 340 (step S108).

Next, the terminal device 300 in the collective connection mode transmits, to the management server 400, information in which the acquired first identification code CD1 and the plural sets of identification information IF are associated with each other. In the present embodiment, the terminal device 300 in the collective connection mode transmits, to the management server 400, information in which the acquired first identification code CD1 is associated with the first identification information IF1 and the second identification information IF2 (step S109). At this time, the terminal device 300 may separately transmit information in which the first identification code CD1 and the first identification information IF1 are associated with each other and information in which the first identification code CD1 and the second identification information IF2 are associated with each other.

Next, the management server 400 stores, in the database 467, information in which the first identification code CD1 received in step S109 is associated with the first identification information IF1 and the second identification information IF2 (step S110).

In the present embodiment, the management server 400 stores the received information in the database 467 by dividing the received information into a record of information associating the first identification code CD1 with the first identification information IF1 and a record of information associating the first identification code CD1 with the second identification information IF2.

Next, in response to an operation by the user U, the first information processing device 200A requests the management server 400 to transmit the first identification code CD1 corresponding to the first identification information IF1 stored in the second storage section 260 (step S111).

Next, the management server 400 extracts, from the database 467, the first identification code CD1 corresponding to the first identification information IF1 included in the received request, and transmits it to the first information processing device 200A, which was the transmission source of the request (step S112).

Next, in response to an operation by the user U, the fourth information processing device 200B requests the management server 400 to transmit the first identification code CD1 corresponding to the second identification information IF2 stored in the second storage section 260 (step S113).

Next, the management server 400 extracts, from the database 467, the first identification code CD1 corresponding to the second identification information IF2 included in the received request, and transmits the first identification code CD1 to the fourth information processing device 200B, which was the transmission source of the request (step S114).

After receiving the first identification code CD1, the first information processing device 200A transmits a deletion request to the management server 400 (step S115). The deletion request transmitted at this time may include the first identification code CD1 stored in the first information processing device 200A.

Next, the management server 400 that received the deletion request deletes, from the database 467, the information associating the first identification information IF1 that corresponds to the deletion request with the first identification code CD1 (step S116).

Next, the management server 400 transmits deletion completion information to the first information processing device 200A, which was the transmission source of the deletion request (step S117).

Next, the first information processing device 200A that received the deletion completion information connects to the projector 100 using the first identification code CD1 received in step S112 (step S118).

After receiving the first identification code CD1, the fourth information processing device 200B transmits a deletion request to the management server 400 (step S119). The deletion request transmitted at this time may include the second identification information IF2 stored in the fourth information processing device 200B.

Next, the management server 400 that received the deletion request deletes, from the database 467, information associating the second identification information IF2 corresponding to the deletion request with the first identification code CD1 (step S120).

Next, the management server 400 transmits deletion completion information to the fourth information processing device 200B, which was the transmission source of the deletion request (step S121).

Next, the fourth information processing device 200B that received the deletion completion information connects to the projector 100 using the first identification code CD1 received in step S114 (step S122). Thereafter, the sequence of FIG. 9 is terminated.

### 8. Alternative Embodiments

The above-described embodiments are suitable embodiments of the present disclosure. However, the present disclosure is not limited to the above-described embodiments, and various modifications can be made without departing from the gist of the present disclosure.

In the first embodiment and the second embodiment, it is described that the information processing device 200 transmits the deletion request to the management server 400 before the information processing device 200 is connected to the projector 100. However, the timing at which the information processing device 200 transmits the deletion request may be any timing as long as it is after the information processing device 200 receives the first identification code CD1 from the management server 400.

Hereinafter, in the projection system 1 having the same configuration as that of the first embodiment, first to third alternative embodiments will be described in which the timing of transmitting the deletion request is changed.

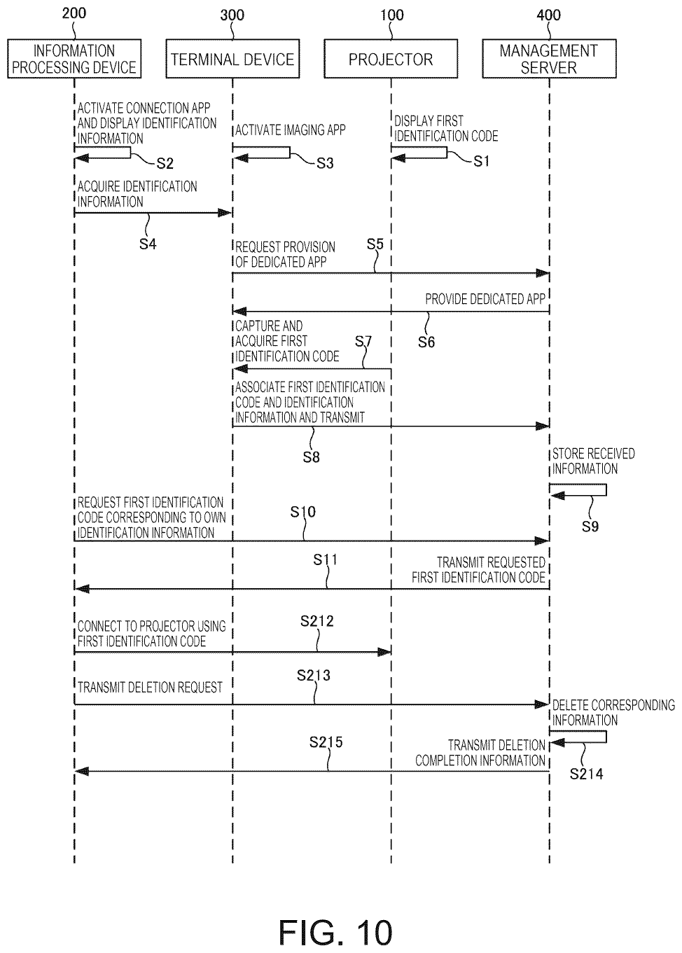

FIG. 10 is a sequence diagram of the projection system 1 according to the first alternative embodiment. Note that in the first alternative embodiment, the value of the communication setting 183 is set to a value at which the projector 100 and the information processing device 200 are connected to each other via the communication network NW.

In the first alternative embodiment, the projection system 1 performs step S1 to step S11 in the same manner as in the first embodiment, and causes the information processing device 200 to acquire the first identification code CD1.

Thereafter, the information processing device 200 connects to the projector 100 via the communication network NW using the acquired first identification code CD1 before transmitting the deletion request (step S212). Therefore, even after step S212, the information processing device 200 can communicate with the management server 400 via the communication network NW.

Next, the information processing device 200 transmits a deletion request to management server 400 (step S213). Next, the management server 400 deletes the information corresponding to the deletion request from the database 467 (step S214). Further, the management server 400 transmits deletion completion information to the information processing device 200, which was the transmission source of the deletion request (step S215).

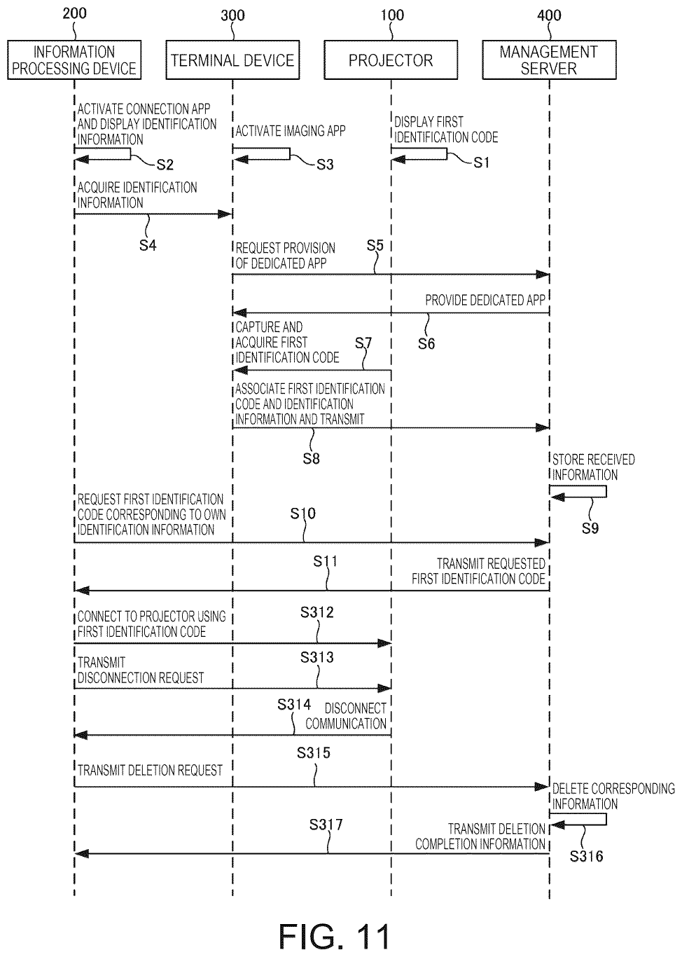

FIG. 11 is a sequence diagram of the projection system 1 according to the second alternative embodiment. Note that in the second alternative embodiment, the value of the communication setting 183 is set to a value that connects the projector 100 and the information processing device 200 to each other via the communication network NW.

In the second alternative embodiment, the projection system 1 performs step S1 to step S11 in the same manner as in the first embodiment, and causes the information processing device 200 to acquire the first identification code CD1.

Thereafter, the information processing device 200 connects to the projector 100 via the communication network NW using the acquired first identification code CD1 before transmitting the deletion request (step S312). Therefore, even after step S312, the information processing device 200 can communicate with the management server 400 via the communication network NW.

Next, after the projection by the projector 100 ends, the information processing device 200 transmits a disconnection request to the projector 100 in accordance with the operation by the user U (step S313). The projector 100 that received the disconnection request disconnects communication with the information processing device 200 (step S314).

Next, the information processing device 200 transmits a deletion request to the management server 400 (step S315). The management server 400 that received the deletion request deletes the information corresponding to the deletion request from the database 467 (step S316). Next, the management server 400 transmits deletion completion information to the information processing device 200, which was the transmission source of the deletion request (step S317).

In the first and second alternative embodiments, the projector 100 and the information processing device 200 are connected to each other via the communication network NW. Therefore, even after the connection with the projector 100, the information processing device 200 can transmit the deletion request to the management server 400 and receive the deletion completion information from the management server 200, without performing a reconnection with the communication network NW.

However, in the case of transmitting the deletion request immediately after receiving the first identification code CD1 as in the first embodiment and the first alternative embodiment, it is not necessary to continue the loop process of determining whether or not the connection between the information processing device 200 and the projector 100 is disconnected. Therefore, in the first embodiment and the first alternative embodiment, the load on the information processing device 200 is easily reduced as compared with the second alternative embodiment.

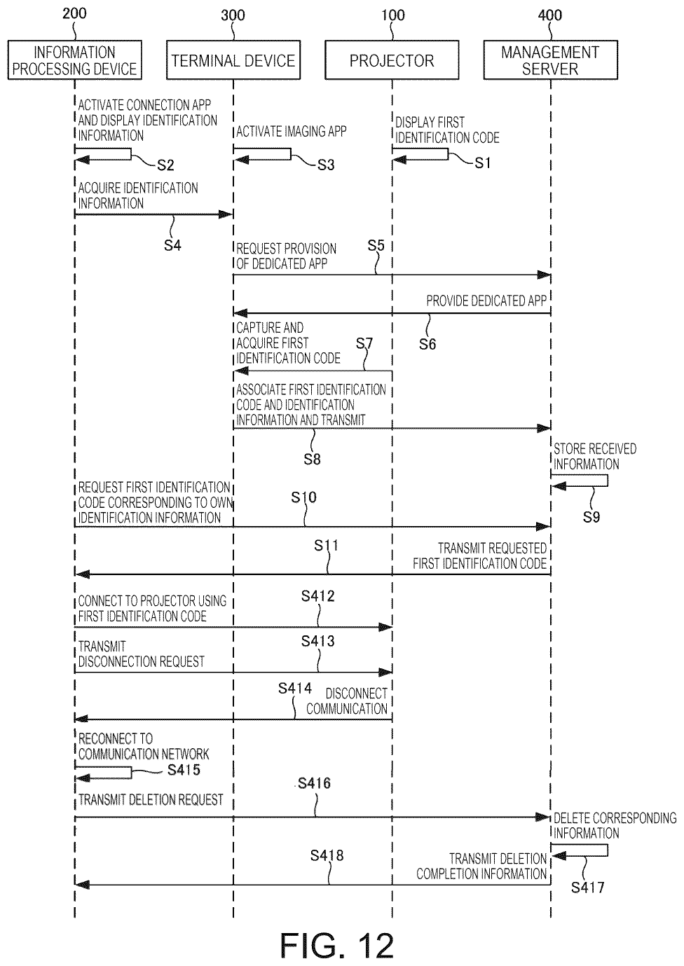

FIG. 12 is a sequence diagram of the projection system 1 according to the third alternative embodiment. Note that in the third alternative embodiment, the value of the communication setting 183 is set to a value that connects the projector 100 and the information processing device 200 directly to each other without the communication network NW.

In the third alternative embodiment, the projection system 1 performs step S1 to step S11 in the same manner as in the first embodiment, and causes the information processing device 200 to acquire the first identification code CD1.

Thereafter, before transmitting the deletion request, the information processing device 200 uses the acquired first identification code CD1 to connect to the projector 100, without the communication network NW interposed therebetween (step S412). That is, in step S412, communication between the information processing device 200 and the communication network NW is disconnected.

Next, after projection by the projector 100 ends, the information processing device 200 transmits a disconnection request to the projector 100 in accordance with the operation by the user U (step S413). The projector 100 that received the disconnection request disconnects communication with the information processing device 200 (step S414).

Next, the information processing device 200 reconnects to the communication network NW (step S415). By this, communication is possible between the information processing device 200 and the management server 400.

Next, the information processing device 200 transmits a deletion request to the management server 400 (step S416). The management server 400 that received the deletion request deletes the information corresponding to the deletion request from the database 467 (step S417). Next, the management server 400 transmits deletion completion information to the information processing device 200, which was the transmission source of the deletion request (step S418).

In the third alternative embodiment, the projector 100 and the information processing device 200 are connected to each other without the communication network NW. Therefore, the information processing device 200 can transmit the deletion request to the management server 400 and receive the deletion completion information from the management server 200 by disconnecting the connection with the projector 100 and reconnecting the projector 100 to the communication network NW.

Each functional section of the projector 100 shown in FIG. 2, the information processing device 200 shown in FIG. 3, the terminal device 300 shown in FIGS. 4 and 8, and the management server 400 shown in FIG. 5 shows a functional configuration, and a specific implementation form is not particularly limited. That is, hardware individually corresponding to each functional section does not necessarily need to be mounted, and it is of course possible to adopt a configuration in which the functions of a plurality of functional sections are realized by one processor executing a program. In the above embodiment, a part of the functions realized by software may be realized by hardware. In the embodiment described above, a part of the functions realized by hardware of the projector 100, the information processing device 200, the terminal device 300, or the management server 400 may be realized by software. In addition, the specific detailed configuration of each of the other sections of the projector 100 can also be arbitrarily changed without departing from the gist of the disclosure.

The processing units of the sequence diagrams shown in FIGS. 6, 9, 10, 11, and 12 are obtained by dividing the processing of the projection system 1 according to the main processing contents in order to facilitate understanding of the processing. The present disclosure is not limited by the way of division and the names of the sequence diagrams shown in FIGS. 6, 9, 10, 11, and 12. The processing of the projection system 1 can be divided into more processing units according to the processing content, or can be divided so that one processing section includes more processing. The processing order of the flowcharts is not limited to the shown examples.

In the embodiments described above, the liquid crystal panels 145 provided in the light modulation device 143 may be transmissive liquid crystal panels or reflective liquid crystal panels. The light modulation device 143 may include a digital mirror device or may include a combination of a digital mirror device and a color wheel. The light modulation device 143 may instead be a liquid crystal panel or a DMD, or may be any other component that can modulate light emitted from a light source.

### SUMMARY OF THE DISCLOSURE

Hereinafter, the summary of the present disclosure will be noted.

### Note 1

A connection method includes displaying, using a projection device, a first identification code for identifying the projection device; acquiring, by a second information processing device, first identification information for identifying a first information processing device; capturing, by the second information processing device, an image of the first identification code; using the second information processing device, associating the first identification code and the first identification information with each other and transmitting, to a third information processing device, information that associates the first identification code and the first identification information with each other; receiving, by the first information processing device, the first identification code corresponding to the first identification information from the third information processing device; and connecting to the projection device using the first information processing device.

By this, the first identification information and the captured first identification code can be easily associated with each other using the second information processing device, and the first information processing device can receive the first identification code via the third information processing device. Therefore, it is possible to reduce the time and effort when the first information processing device and the projection device are to be connected to each other, and to improve the convenience for the user.

### Note 2

The connection method according to Note 1, wherein acquiring the first identification information for identifying the first information processing device includes capturing, by the second information processing device, the first identification information displayed by the first information processing device.

By this, when the first identification information is acquired by the second information processing device, the first identification information can be acquired by capturing an image, without performing an input operation or the like of the first identification information. Therefore, it is possible to reduce the time and effort when the first information processing device and the projection device are to be connected to each other, and to improve the convenience for the user.

### Note 3

The connection method according to Note 1 or Note 2, further including transmitting, using the first information processing device, a deletion request to the third information processing device after receiving the first identification code from the third information processing device and based on the deletion request, deleting, using the third information processing device, information associating the first identification information with the first identification code.

By this, when the first information processing device and the projection device are connected to each other, it is possible to prevent the first information processing device from receiving the first identification code of another projection device connected in the past. Therefore, when the first information processing device and the projection device are connected to each other, it is possible to prevent erroneous connection to another projection device.

### Note 4

The connection method according to any of Notes 1 to Note 3, further including displaying, using a fourth information processing device, second identification information for identifying the fourth information processing device; acquiring, by the second information processing device, the second identification information; using the second information processing device, associating the first identification code and the second identification information and transmitting, to the third information processing device, information that associates the first identification code and the second identification information; receiving, by the fourth information processing device, the first identification code corresponding to the second identification information from the third information processing device; and connecting to the projection device using the fourth information processing device.

By this, the first information processing device and the fourth information processing device can therefore both be easily connected to the projection device. Therefore, it is possible to reduce the time and effort when the first information processing device and the fourth projection device are connected to the projection device, and to improve convenience for the user.

What is claimed is:

1. A connection method comprising:
displaying, using a projection device, a first identification code for identifying the projection device;
acquiring, by a second information processing device, first identification information for identifying a first information processing device;
capturing, by the second information processing device, an image of the first identification code;
using the second information processing device, associating the first identification code and the first identification information with each other and transmitting, to a third information processing device, information that associates the first identification code and the first identification information with each other;
receiving, by the first information processing device, the first identification code corresponding to the first identification information from the third information processing device; and
connecting to the projection device using the first information processing device.

2. A connection method according to claim 1, wherein
acquiring the first identification information for identifying the first information processing device includes
capturing, by the second information processing device, the first identification information displayed by the first information processing device.

3. The connection method according to claim 1, further comprising:
transmitting, using the first information processing device, a deletion request to the third information processing device after receiving the first identification code from the third information processing device and
based on the deletion request, deleting, using the third information processing device, information associating the first identification information with the first identification code.

4. The connection method according to claim 1, further comprising:
displaying, using a fourth information processing device, second identification information for identifying the fourth information processing device;
acquiring, by the second information processing device, the second identification information;
using the second information processing device, associating the first identification code and the second identification information and transmitting, to the third information processing device, information that associates the first identification code and the second identification information;
receiving, by the fourth information processing device, the first identification code corresponding to the second identification information from the third information processing device; and
connecting to the projection device using the fourth information processing device.
